(19) United States
(12) Patent Application Publication
(10) Pub. No.: US 2007/0297313 A1
(43) Pub. Date: Dec. 27, 2007

(54) OPTICAL PICKUP

(76) Inventors: Nobuhiro Konuma, Yokohama (JP); Takeshi Nakao, Sagamihara (JP)

Correspondence Address: ANTONELLI, TERRY, STOUT & KRAUS, LLP, 1300 NORTH SEVENTEENTH STREET, SUITE 1800, ARLINGTON, VA, 22209-3873, US

(21) Appl. No.: 11/764,816

(22) Filed: Jun. 19, 2007

(30) Foreign Application Priority Data
Jun. 23, 2006 (JP) 2007-173288

(51) Int. Cl. G11B 7/00

(52) U.S. Cl. 369/112.08; 369/112.23

(57) ABSTRACT

An optical pickup has a first compatible objective and a second compatible objective, the first objective having a diffractive lens structure capable of recording and playback to and from CD and HD DVD, the second objective having a diffractive lens structure capable of recording and playback to and from both DVD and BD. The first objective has the diffractive lens structure that meets the condition of 0.75≦(λ1×m1)/(λ3×m3)≦0.99, where m1 and m3 are diffraction orders of diffracted lights used to read and write CD and HD DVD. The second objective has the diffractive lens structure that meets the condition of 0.75≦(λ4×m4)/(λ2×m2)≦0.99, where m2 and m4 are diffraction orders of diffracted lights used to read and write DVD and BD.

### INCORPORATED BY REFERENCE

The present invention claims priority from Japanese application JP 2006-173288 filed on Jun. 23, 2006, the content of which is hereby incorporated by reference into this application.

### BACKGROUND OF THE INVENTION

The present invention relates to an optical pickup capable of recording and playing back information into and from a plurality of kinds of optical discs and more particularly to an optical pickup capable of recording and playing back information into and from a plurality of kinds of optical discs that use different wavelengths.

Optical pickups have been known which use an objective lens that are compatible with two kinds of optical discs—CDs and DVDs. For example, Japanese Patent No. 3,689,266 discloses an objective having a diffractive lens structure in a surface of a refractive lens.

### SUMMARY OF THE INVENTION

The objective lens in Japanese Patent No. 3,689,266 has a wavelength dependency such that diffracted beams of the same diffraction order form desirable wave fronts with respect to two kinds of optical discs. It is described desirable to design a diffractive lens structure so that the ratio of laser wavelengths for the two kinds of optical discs satisfy the following conditions in order to generate enough spherical aberration:

0.75<wavelength ratio (λ2/λ1)<0.87

where λ1 is a wavelength for CD and λ2 is a wavelength for DVD.

Substituting into the above expression the center values of the laser wavelengths currently in use, i.e., the wavelength for CD λ1=785 nm and the wavelength for DVD λ2=660 nm, the resultant ratio of wavelengths is λ2/λ1=660/785≈0.84. This satisfies the above design condition, so the diffraction efficiency can be made higher than approximately 90%.

Therefore, the use of the objective lens of Japanese Patent No. 3,689,266 makes it possible to record or play back two kinds of optical discs—CD and DVD—with a single objective and to obtain an optical pickup with high light utilization.

With the objective lens of Japanese Patent No. 3,689,266, however, if the wavelength of the next generation DVD is 405 nm, the design requirement for the wavelength ratio cannot be met.

As the next generation DVDs, two kinds of optical discs with different substrate thicknesses—a first next generation DVD or HD DVD (abbreviated HD) and a second next generation DVD or Blu-ray Disc (abbreviated BD). As the wavelength for the laser beam, 405 nm is currently recommended for both of them.

First, we calculated the wavelength ratio for a CD/HD-compatible read/write optical pickup by substituting center values of currently used laser wavelengths into the above formula. The wavelength ratio λ3/λ1=405/785≈0.52 where λ1 is a CD wavelength of 785 nm and λ3 is an HD wavelength of 405 nm. This calculated wavelength ratio does not satisfy the above design requirement.

Next, we calculated the wavelength ratio for a DVD/BD-compatible read/write optical pickup by substituting center values of currently used laser wavelengths into the above formula. The wavelength ratio λ4/λ2=405/660≈0.61 where λ2 is a DVD wavelength of 660 nm and λ4 is a BD wavelength of 405 nm. This calculated wavelength ratio does not satisfy the above design requirement.

Similarly, the CD/BD-compatible read/write optical pickup and the DVD/HD-compatible read/write optical pickup cannot satisfy the above design requirement of the wavelength ratio.

Thus, the CD/first next generation DVD compatible objective lens and the DVD/second next generation DVD compatible objective lens according to the above Japanese Patent No. 3,689,266 cannot satisfy the wavelength ratio design requirement and have a problem that a pickup using these objective lens can only gain a light utilization of less than approximately 90%.

Since the CD/DVD compatible objective lens has already been commercialized, if the HD/BD compatible objective lens can be put to practical use, the objective lens can read/write the four kinds of media. However, in the case of the HD/BD compatible objective lens, if the laser wavelengths used λ3, λ4 are both 405 nm, the wavelength ratio=1.00, which does not satisfy the above design requirement. This poses a problem that if the same wavelengths are used, the spherical aberration cannot be corrected.

Therefore, to realize an optical pickup capable of reading and writing four kinds of optical discs—CD, DVD, HD and BD—two objective lenses each compatible with two different optical discs may be used. With the conventional technologies, however, a desired optical pickup cannot be realized because of the problem of not being able to meet the wavelength ratio design requirement.

The present invention has been accomplished in light of the problem of the conventional technologies and it is an object of this invention to provide a compatible optical pickup capable of reading and writing information of a plurality of kinds of optical discs using different wavelengths.

To solve the above problem, this invention provides an optical pickup that at least writes or reads information into or from a plurality of kinds of optical discs by applying diffractive beams of different diffraction orders to the different kinds of optical discs.

The plurality of optical discs include at least four kinds of optical discs—a first optical disc that performs read/write operations using a laser beam of wavelength λ1, a second optical disc that performs read/write operations using a laser beam of wavelength λ2 shorter than the wavelength λ1, a third optical disc that performs read/write operations using a laser beam of wavelength λ3 shorter than the wavelength λ2, and a fourth optical disc that performs read/write operations using a laser beam of wavelength λ4 shorter than the wavelength λ2.

The optical pickup of this invention, for example, may be constructed of two objective lenses—a first compatible objective lens having a diffractive lens structure that can perform read/write operations on the CD and the first next generation DVD and a second compatible objective lens having a diffractive lens structure that can perform read/write operations on the DVD and the second generation DVD—and a spherical aberration correction means. The diffractive lens structure of the first compatible objective lens is designed so that a diffracted light of diffraction order m1 from a beam for CD having a wavelength λ1 and a diffracted light of diffraction order m3 from a beam for the first next generation DVD having a wavelength λ3 satisfy the following requirement for the ratio of wavelengths multiplied by diffraction orders:

0.75≦(λ1×m1)/(λ3×m3)≦0.99 (1)

Then, combined with the spherical aberration correction means, the optical pickup is constructed to have a wavelength dependency that enables satisfactory wave fronts to be formed on two kinds of optical discs. The diffractive lens structure of the second compatible objective lens is designed so that a diffracted light of diffraction order m2 from a beam for DVD having a wavelength λ2 and a diffracted light of diffraction order m4 from a beam for the second generation DVD having a wavelength λ4 satisfy the following requirement for the ratio of wavelengths multiplied by diffraction orders:

0.75≦(λ4×m4)/(λ2×m2)≦0.99 (2)

Then, combined with the spherical aberration correction means, the optical pickup is constructed to have a wavelength dependency that enables satisfactory wave fronts to be formed on two kinds of optical discs.

The optical pickup of this invention is one that performs at least one of recording and playback of information into and from a plurality of kinds of optical discs. The plurality of optical discs may, for example, include a first optical disc that is written and read by a first laser beam of wavelength λ1, a second optical disc that is written and read by a second laser beam of wavelength λ2 shorter than the wavelength λ1, a third optical disc that is written and read by a third laser beam of wavelength λ3 shorter than the wavelength λ2, and a fourth optical disc that is written and read by a fourth laser beam of wavelength λ4 almost equal to the wavelength λ3. At this time, the optical pickup according to this invention may be constructed of a first laser beam source to generate the first laser beam, a second laser beam source to generate the second laser beam, a third laser beam source to generate the third laser beam, a fourth laser beam source to generate the fourth laser beam, a first objective lens used to read/write the first and third optical discs, a second objective lens used to read/write the second and fourth optical discs, and a spherical aberration correction means.

The first objective lens may focus a kth diffracted beam (k is an integer) of the first laser beam on a layer of the first optical disc in which information is recorded and also focus a jth diffracted beam (j is an integer not equal to k) of the first laser beam on a layer of the third optical disc in which information is recorded. The second objective lens may focus an mth diffracted beam (m is an integer) of the second laser beam on a layer of the second optical disc in which information is recorded and also focus an nth diffracted beam (n is an integer not equal to m) of the second laser beam on a layer of the fourth optical disc in which information is recorded.

Other objects, features and advantages of the invention will become apparent from the following description of the embodiments of the invention taken in conjunction with the accompanying drawings.

### BRIEF DESCRIPTION OF THE DRAWINGS

FIG. 1A is an explanatory diagram showing an outline of a first objective lens used in an optical pickup of the first embodiment.

FIG. 1B is an explanatory diagram showing an outline of a second objective lens used in the optical pickup of the first embodiment.

FIG. 2 is an explanatory diagram showing an optical system of the optical pickup using the first and second objective lens of the first embodiment.

### DESCRIPTION OF THE EMBODIMENTS

Now, some embodiments of an optical pickup according to this invention will be described in detail by referring to the accompanying drawings. It should be noted, however, that the present invention is not limited to the following embodiments and that various modifications and improvements may be made within a scope of this invention.

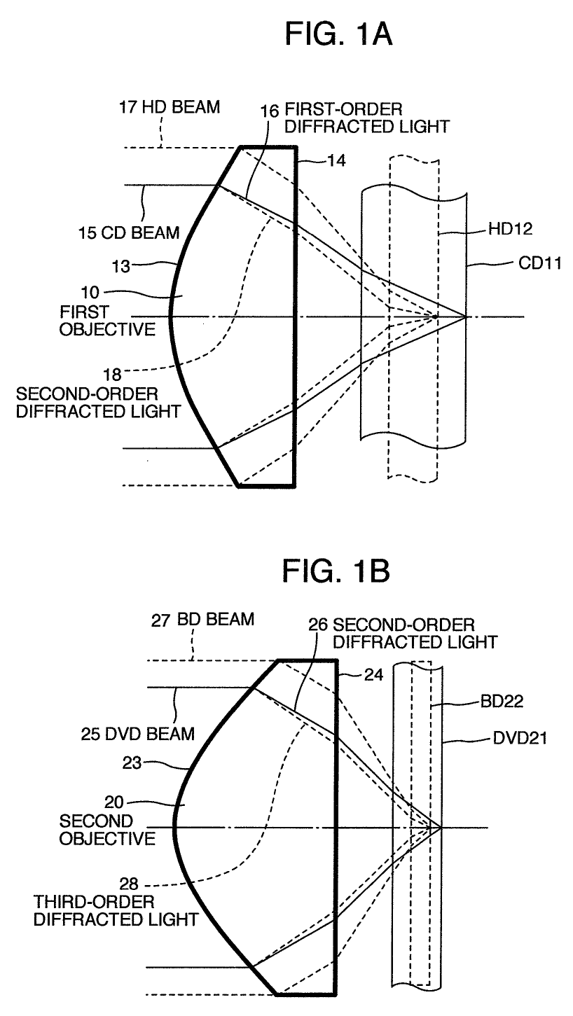

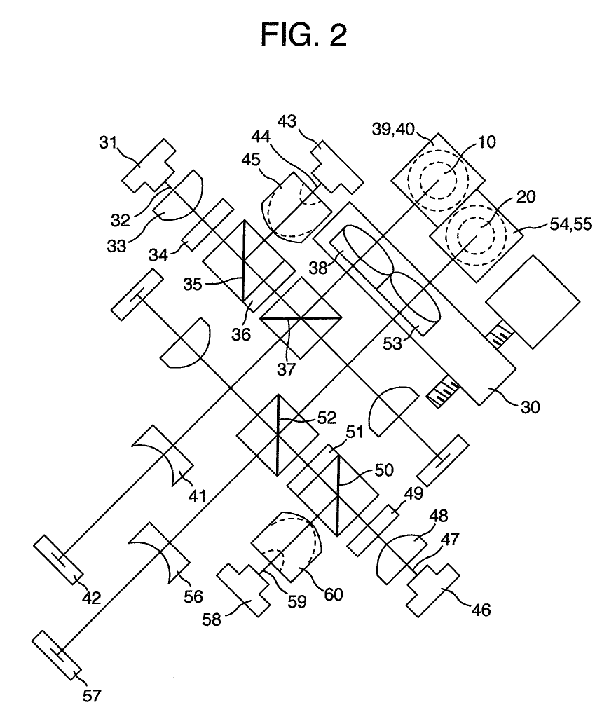

FIG. 1A and FIG. 1B show external views of a first objective lens 10 and a second objective lens 20 used in the optical pickup of the first embodiment. FIG. 2 shows an optical system of the optical pickup according to this invention. The optical pickup according to this invention can perform at least one of writing and reading of information into and from a plurality of kinds of optical discs by applying diffracted beams of different diffraction orders to the discs. Detailed explanations will follow.

As shown in FIG. 2, the optical pickup according to this invention has four laser beam sources—a laser beam source 31 for reading and writing CDs (hereinafter referred to as a CD laser), a laser beam source 46 for reading and writing DVDs (referred to as a DVD laser), a laser beam source 43 for reading and writing HD DVDs (referred to as an HD laser) and a laser beam source 58 for reading and writing BDs (referred to as a BD laser). The CD laser 31 is a laser beam source with an oscillating wavelength range of 760 nm to 810 nm and, in the first embodiment, uses a laser beam source with an oscillating wavelength of 785 nm. The DVD laser 46 is a laser beam source with an oscillating wavelength range of 640 nm to 680 nm and, in the first embodiment, uses a laser beam source with an oscillating wavelength of 660 nm. The HD laser 43 and the BD laser 58 are laser beam sources with oscillating wavelength ranges of 400-410 nm and 440-450 nm and, in the first embodiment, use laser beam sources with an oscillating wavelength of 405 nm. These laser beam sources can be changed according to the standards of the optical discs used. For example, if the next-next-generation optical disc performs the recording and playback using a laser beam of a wavelength shorter than the oscillating wavelength of HD laser and BD laser, a laser beam source having a shorter oscillating wavelength than those of the HD laser and BD laser can be used.

As shown in FIG. 1A, the first objective lens 10 is compatible with the CD 11 described in a solid line and the HD 12 described in a dashed line. The first objective lens 10 is a single lens having two aspherical surfaces 13, 14 with the diffraction structure formed in the aspherical surface 13 shown in a thick solid line. The diffraction structure of the first objective lens 10 is a blaze type diffraction grating which, for a CD beam 15 of wavelength λ1=785 nm shown in a solid line and having passed the spherical aberration correction means 30 of FIG. 2, can focus a diffracted beam 16 of first diffraction order (m1=1) on a layer of the CD where information is recorded. For an HD beam 17 of wavelength λ3=405 nm shown in a dashed line, the first objective lens 10 can focus a diffracted beam 18 of second diffraction order (m3=2) on a layer of the HD in which information is recorded. In this way the recording and playback of information to and from CD and HD are performed using diffracted beams of different orders.

It is desired that the diffractive lens structure of the first objective lens 10 be designed so that a diffracted light 16 of first diffraction order (m1=1) from a beam 15 for CD 11 having a wavelength λ1 and a diffracted light 18 of second diffraction order (m3=2) from a beam 17 for the first next generation DVD having a wavelength λ3 satisfy the following requirement for the ratio of wavelengths multiplied by diffraction orders:

0.75≦(λ1×m1)/(λ3×m3)≦0.99 (1)

that is,

0.75≦(λ1×1)/(λ3×2)≦0.99.

Substituting into the above expression the center values of the laser wavelengths currently in use, i.e., the wavelength for CD λ1=785 nm and the wavelength for HD λ3=405 nm, the resultant ratio of wavelengths is (λ2×1)/(λ3×2)=(785×1)/(405×2)=785/810≈0.97. This satisfies the above design condition (1).

As shown in FIG. 1B, the second objective lens 20 is compatible with a DVD 21 shown in a solid line and a BD 22 shown in a dashed line. The second objective lens 20 is a single lens having two aspherical surfaces 23, 24 with the diffraction structure formed in the aspherical surface 23 shown in a thick solid line. The diffraction structure of the second objective lens 20 is a blaze type diffraction grating which, for a DVD beam 25 of wavelength λ2=660 nm shown in a solid line and having passed the spherical aberration correction means 30 of FIG. 2, can focus a diffracted beam 26 of second diffraction order (m2=2) on a layer of the DVD where information is recorded. For an BD beam 27 of wavelength λ4=405 nm shown in a dashed line, the second objective lens 20 can focus a diffracted beam 28 of third diffraction order (m4=3) on a layer of the BD in which information is recorded. In this way the recording and playback of information to and from DVD and BD are performed using diffracted beams of different diffraction orders.

It is desired that the diffractive lens structure be designed so that a diffracted light 26 of second diffraction order (m2=2) from a beam 25 for DVD 21 having a wavelength λ2 and a diffracted light 28 of third diffraction order (m4=3) from a beam 27 for the second next generation DVD such as BD 22 having a wavelength λ4 satisfy the following requirement for the ratio of wavelengths multiplied by diffraction orders:

0.75≦(λ4×m4)/(λ2×m2)≦0.99 (2)

that is,

0.75≦(λ4×3)/(λ2×2)≦0.99.

Substituting into the above expression the center values of the laser wavelengths currently in use, i.e., the wavelength for DVD λ2=660 nm and the wavelength for BD λ4=405 nm, the resultant ratio of wavelengths is (λ4×3)/(λ2×2)=(405×3)/(660×2)=1215/1320≈0.92. This satisfies the above design condition (2).

FIG. 2 is an explanatory diagram showing an optical system of the optical pickup using the first objective lens 10 and the second objective lens 20 of the first embodiment.

A CD beam 32 emitted from the CD laser 31 passes through the lens 33, a diffraction grating 34, a polarization beam splitter 35 and a half waveplate 36 and is reflected by a polarization beam splitter 37. Then, the beam passes through a lens 38, which forms a spherical aberration correction means 30, and is reflected by a mirror 39. It then passes through a quarter waveplate 40 and enters an objective lens 10 which focuses it on the CD 11, as explained in connection with FIG. 1A.

After being reflected by the CD 11, the beam passes through the objective lens 10 and the quarter waveplate 40 and is reflected by the mirror 39. It then passes through the lens 38, the polarization beam splitter 37 and a lens 41 before entering a photodetector 42.

An HD beam 44 emitted from the HD laser 43 passes through a lens 45 and is reflected by the polarization beam splitter 35. It then passes through the half waveplate 36 and is reflected by the polarization beam splitter 37. Then it passes through the lens 38, which forms the spherical aberration correction means 30, and is reflected by the mirror 39. The beam then passes through the quarter waveplate 40 and enters the objective lens 10 which focuses the beam on the HD 12, as explained in connection with FIG. 1A.

After being reflected from the HD 12, the light passes through the objective lens 10 and the quarter waveplate 40 and is reflected by the mirror 39. It then passes through the lens 38, polarization beam splitter 37 and lens 41 and enters the photodetector 42.

A DVD beam 47 emitted from the DVD laser 46 passes through a lens 48, a diffraction grating 49, a polarization beam splitter 50 and a half waveplate 51 and is reflected by a polarization beam splitter 52. It then passes through a lens 53, which forms the spherical aberration correction means 30, and is reflected by a mirror 54. The light then passes through a quarter waveplate 55 and enters an objective lens 20 which focuses it on the DVD 21, as explained in connection with FIG. 1B.

After being reflected by the DVD 21, the light passes through the objective lens 20 and the quarter waveplate 55 and is reflected by the mirror 54. It then passes through the lens 53, the polarization beam splitter 52 and a lens 56 and enters a photodetector 57.

A BD beam 59 emitted from the BD laser 58 passes through a lens 60 and is reflected by the polarization beam splitter 50. It then passes through the half waveplate 36 and is reflected by the polarization beam splitter 52. Then it passes through the lens 53, which forms the spherical aberration correction means 30, and is reflected by the mirror 54. It further passes through the quarter waveplate 55 and enters the objective lens 20, which focuses it on the BD 22, as explained in connection with FIG. 1B.

After being reflected by the BD 22, the light passes through the objective lens 20 and the quarter waveplate 55 and is reflected by the mirror 54. It then passes through the lens 53, the polarization beam splitter 52 and the lens 56 before entering the photodetector 57.

The spherical aberration correction means 30 comprises the lens 38 and the lens 53 and is designed to be able to change the spherical aberration correction. The lens 38, in combination with the objective lens 10, corrects the spherical aberrations of the CD 11 and the HD 12 well. The lens 53, in combination with the objective lens 20, corrects the spherical aberrations of the DVD 21 and the BD 22 well.

To omit the lens 38, the design needs to satisfy the following condition in stead of the condition of equation (1).

0.75≦(λ1×m1)/(λ3×m3)≦0.87 (3)

That is, in the case of the first embodiment, the following condition must be met.

0.75≦(λ1×1)/(λ3×2)≦0.87

Where the condition of equation (3) is met, if the lens 38 is used rather than being omitted, the degree of freedom in the spherical aberration correction design for the objective lens 10 increases, making it possible to better correct the spherical aberration.

To omit the lens 53, the design needs to satisfy the following condition in stead of the condition of equation (2).

0.75≦(λ4×m4)/(λ2×m2)≦0.87 (4)

That is, in the case of the first embodiment, the following condition must be met.

0.75≦(λ4×3)/(λ2×2)≦0.87

If the lens 53 is used rather than being omitted even when the condition of equation (4) is met, the degree of freedom in the spherical aberration correction design for the objective lens 10 increases, making it possible to better correct the spherical aberration.

Although in the first embodiment the wavelength of the laser beam for reading and writing the next-generation DVDs is set at 405 nm, it is not limited to this wavelength. For example, a laser beam with a wavelength of 400-410 nm or 440-450 nm may be used.

In the second embodiment, the CD is supposed to have a wavelength λ1 of 785 nm and the HD a wavelength λ3 of 445 nm. In this case, the ratio of wavelengths is

(λ1×1)/(λ3×2)=(785×1)/(445×2)=785/890≈0.88

This is close to the value of the design condition (3) for the wavelength ratio, so this embodiment can correct the spherical aberration better than the first embodiment.

When the wavelength λ3 is changed from 405 nm to 445 nm, the numerical aperture of the HD of the objective lens 10 needs to be changed. Since the wavelength λ and the numerical aperture NA are inversely proportional to each other, if the numerical aperture NA=0.65 when the wavelength λ3=405 nm, then the numerical aperture for the wavelength λ3=445 nm is given by

NA=(0.65×445)/405=0.714

In the third embodiment, the CD is supposed to have a wavelength λ1 of 785 nm and the HD a wavelength λ3 of 473 nm. In this case, the ratio of wavelengths is

(λ1×1)/(λ3×2)=(785×1)/(473×2)=785/946≈0.83

This satisfies the design condition (3) for the wavelength ratio, so this embodiment can correct the spherical aberration better than the second embodiment.

The numerical aperture NA for the wavelength λ3=473 nm therefore is

NA=(0.65×473)/405=0.759

Although in the first embodiment, the diffractive lens structure of the second compatible objective uses a diffracted light of second diffraction order (m2=2) from a beam for DVD with a wavelength λ2 and a diffracted light of third diffraction order (m4=3) from a beam for second next-generation DVD with a wavelength λ4, this invention is not limited to this structure. The spherical aberration correction can further be improved by changing a combination of diffraction orders.

In the fourth embodiment, a combination of diffraction orders is m2=3 and m4=4.

Using the center values of the laser wavelengths currently in use, i.e., the wavelength for DVD λ2=660 nm and the wavelength for BD λ4=405 nm, the resultant ratio of wavelengths multiplied by the diffraction orders is

(λ4×m4)/(λ2×m2)=(405×4)/(660×3)=1620/1980≈0.82. This satisfies the above design condition (4).

As described above, the optical pickup according to this invention has two compatible objectives and a spherical aberration correction means, the two compatible objectives being a first compatible objective having a diffractive lens structure capable of reading and writing two kinds of optical discs—CD and first next-generation DVD—and a second compatible objective having a diffractive lens structure capable of reading and writing two kinds of optical discs—DVD and second next-generation DVD. The diffractive lens structure of the first objective is designed so that a diffracted light of diffraction order m1 from a beam for CD with a wavelength λ1 and a diffracted light of diffraction order m3 from a beam for first next-generation DVD satisfy the following requirement for a ratio of the wavelengths multiplied by the diffraction orders:

0.75≦(λ1×m1)/(λ3×m3)≦0.99 (1)

The first compatible objective has a wavelength dependency such that, when combined with the spherical aberration correction means, the first objective can form good wave fronts for the two kinds of optical discs. The diffractive lens structure of the second compatible objective is designed so that a diffracted light of diffraction order m2 from a beam for DVD with a wavelength λ2 and a diffracted light of diffraction order m4 from a beam for second next-generation DVD satisfy the following requirement for a ratio of the wavelengths multiplied by the diffraction orders:

0.75≦(λ4×m4)/(λ2×m2)≦0.99 (2)

The second compatible objective has a wavelength dependency such that, when combined with the spherical aberration correction means, the second compatible objective can form good wave fronts for the two kinds of optical discs. The optical pickup according to this invention can correct spherical aberrations of the diffracted light of diffraction orders determined by the diffractive lens structures of the first and second compatible objectives and also focus them on the respective disc recording surfaces. The optical pickup also has a high light utilization. With this invention, an compatible optical pickup can be provided which can perform read/write operations on four kinds of optical discs—CDs, DVDs, first next-generation DVDs and second next generation DVDs.

The embodiments of the optical pickup according to the present invention have been described in detail. It is noted that this invention is not limited to these embodiments and that various improvements and modifications may be made without departing from the spirit and scope of this invention.

While in the above embodiments the first objective is constructed as a CD-HD compatible objective capable of reading and writing both CD and HD and the second objective is constructed as a DVD-BD compatible objective capable of reading and writing both DVD and BD, this invention is not limited to this construction. For example, the first objective may be constructed to focus a diffracted light from a laser beam of wavelength λ1 on a layer of CD in which information is recorded and also to focus a diffracted light from a laser beam of wavelength λ4 on a layer of BD in which information is recorded. The second objective may be constructed to focus a diffracted light from a laser beam of wavelength λ2 on a layer of DVD in which information is recorded and also to focus a diffracted light from a laser beam of wavelength λ3 on a layer of HD DVD in which information is recorded.

In the above embodiments, while a laser beam source for reading and writing the HD DVD and a laser beam source for reading and writing the BD are provided separately, a single laser beam source may be shared.

With this invention, the optical pickup can perform the reading and writing operations on a plurality of kinds of optical discs that use different wavelengths.

1. An optical pickup to at least write or read information into or from a plurality of kinds of optical discs, wherein the plurality of optical discs include at least four kinds of optical discs, i.e., a first optical disc using a laser beam of wavelength λ1 for read/write operations, a second optical disc using a laser beam of wavelength λ2 shorter than the wavelength λ1 for read/write operations, a third optical disc using a laser beam of wavelength λ3 shorter than the wavelength λ2 for read/write operations and a fourth optical disc using a laser beam of wavelength λ4 shorter than the wavelength λ2, the optical pickup comprising:
a first compatible objective lens having a diffractive lens structure and capable of reading and writing two kinds of optical discs, i.e., the first optical disc and the third optical disc;
a second compatible objective lens having a diffractive lens structure and capable of reading and writing two kinds of optical discs, i.e., the second optical disc and the fourth optical disc; and
a spherical aberration correction means;
wherein the first compatible objective lens has the diffractive lens structure that satisfies an equation (1)
0.75≦(λ1×m1)/(λ3×m3)≦0.99 (1)
where m1 is a diffraction order of a diffracted light used for reading and writing the first optical disc and m3 is a diffraction order of a diffracted light used for reading and writing the third optical disc (m3 is an integer not equal to m1);
wherein the second compatible objective lens has the diffractive lens structure that satisfies an equation (2)
0.75≦(λ4×m4)/(λ2×m2)≦0.99 (2)
where m2 is a diffraction order of a diffracted light used for reading and writing the second optical disc and m4 is a diffraction order of a diffracted light used for reading and writing the fourth optical disc (m4 is an integer not equal to m2).

2. An optical pickup according to claim 1, wherein m1=1 and m3=2.

3. An optical pickup according to claim 1, wherein m2=2 and m4=3.

4. An optical pickup according to claim 1, wherein m2=3 and m4=4.

5. An optical pickup according to claim 1, wherein the wavelength λ1 is 785 nm, the wavelength λ2 is 660 nm and the wavelengths λ3 and λ4 are 405 nm.

6. An optical pickup to at least write or read information into or from a plurality of kinds of optical discs, wherein the plurality of optical discs include at least four kinds of optical discs, i.e., a first optical disc using a first laser beam of wavelength λ1 for read/write operations, a second optical disc using a second laser beam of wavelength λ2 shorter than the wavelength λ1 for read/write operations, a third optical disc using a third laser beam of wavelength λ3 shorter than the wavelength λ2 for read/write operations and a fourth optical disc using a fourth laser beam of wavelength λ4 almost equal to the wavelength λ3, the optical pickup comprising:
a first laser beam source to generate the first laser beam;
a second laser beam source to generate the second laser beam;
a third laser beam source to generate the third laser beam;
a fourth laser beam source to generate the fourth laser beam;
a first objective lens to focus a diffracted light of kth diffraction order (k is an integer) from the first laser beam on a layer of the first optical disc in which information is recorded and to focus a diffracted light of jth diffraction order (j is an integer not equal to k) from the third laser beam on a layer of the third optical disc in which information is recorded;
a second objective lens to focus a diffracted light of mth diffraction order (m is an integer) from the second laser beam on a layer of the second optical disc in which information is recorded and to focus a diffracted light of nth diffraction order (n is an integer not equal to m) from the fourth laser beam on a layer of the fourth optical disc in which information is recorded; and
a spherical aberration correction means.

7. An optical pickup to at least write or read information into or from a plurality of kinds of optical discs by irradiating diffracted beams of different orders to different kinds of optical discs.
